(19) United States
(12) Patent Application Publication
(10) Pub. No.: US 2022/0062837 A1
(43) Pub. Date: Mar. 3, 2022

(54) APPARATUS, METHODS, AND SYSTEMS FOR MIXING, DISPERSING SUBSTANCES

(71) Applicant: NanoRial Technologies Ltd., Oakville (CA)

(72) Inventors: Chitral J. ANGAMMANA, Kitchener (CA); Pushkar KUMAR, Oakville (CA)

(21) Appl. No.: 17/415,318

(22) PCT Filed: Dec. 20, 2019
(86) PCT No.: PCT/CA2019/051886

§ 371 Date: Jun. 17, 2021

Related U.S. Application Data
(60) Provisional application No. 62/783,483, filed on Dec. 21, 2018.

(51) Int. Cl. B01F 7/00; B01F 11/02; B01F 13/00; B01F 15/06; B01F 3/12; C08J 3/215

(52) U.S. Cl. CPC B01F 7/00816; B01F 7/00775; B01F 11/0216; B01F 13/0005; B01F 15/066; B01F 3/1207; C08J 2363/02; C08J 3/215; B01F 2015/062; B01F 2003/125; C08J 2383/04; C08J 2391/00; B01F 3/1242

(57) ABSTRACT

An apparatus for mixing two or more substances, the apparatus comprising: (a) a first surface, the first surface having a first profile, (b) a second surface spaced apart from the first surface, the second surface having a second profile, (c) a mixing gap formed between the first and second profiles of the first surface and the second surface, and (d) at least one input channel in liquid communication with the mixing gap, to feed the mixing gap with the two or more substances to be mixed.

### BACKGROUND

### Technical Field

The implementations disclosed herein relate to the manufacturing of particle dispersions, and, in particular to apparatus, methods, systems for mixing and dispersing homogeneously one or more substances and to compositions, mixtures, dispersions or compounds obtained with an apparatus of the present disclosure.

### Description of the Related Art

In industrial processing, mixing is an operation that involves manipulation of a heterogeneous material system and converts the heterogeneous material system to a more homogeneous system. Mixing is performed to allow heat and/or mass transfer to occur between one or more streams, components or phases. Modern industrial processing always involves some form of mixing. With the right equipment, it is possible to mix a solid, liquid or gas into another solid, liquid or gas. The type of operation and equipment used during mixing depends on the state of materials being mixed (liquid, semi-solid, or solid) and the miscibility of the materials being processed.

Particle dispersion refers to a homogeneous blend of particles suspended in a liquid. The process of dispersion involves understanding particle size, surface area, processing equipment, and use of raw materials. When mixing a solid with a liquid the solids have a tendency to agglomerate together. These large groupings of particles can create an uneven dispersion in the liquid/compound/composite. One may need sophisticated characterization equipment like high resolution optical microscope and/or scanning electron microscope (SEM) to observe these large agglomerations because they are still very small and difficult to observe with naked eye.

### BRIEF SUMMARY

In one implementation, the present disclosure is of an apparatus for mixing two or more substances into a mixed blend, the apparatus including: (a) a first surface, the first surface having a first profile, (b) a second surface spaced apart from the first surface, the second surface having a second profile, (c) a mixing gap formed between the first and second profiles of the first surface and the second surface, and (d) at least one input channel in liquid communication with the mixing gap, to feed the mixing gap with the two or more substances to be mixed, wherein at least one of the first surface and the second surface is a rotating surface, and wherein the first profile and the second profile are designed or configured to mix and disperse the two or more substances flowing through the mixing gap together using one or more of high shear, cavitation and impacting forces.

In one implementation of the apparatus of the present disclosure, the profile of at least one of the first surface and the second surface comprises alternate curved surfaces.

In another implementation of the apparatus of the present disclosure, the profile of both the first surface and the second surface comprise alternate curved surfaces.

In another implementation of the apparatus of the present disclosure, the apparatus further comprises a container for receiving the mixed substances from the gap.

In another implementation of the apparatus of the present disclosure, the mixing gap includes a narrow portion and a broad portion, wherein distance between the first surface and the second surface is longer in the broad portion than in the narrow portion.

In another implementation of the apparatus of the present disclosure, the apparatus further comprises a driving means linked to the first surface for rotating the first surface in the predetermined direction.

In another implementation of the apparatus of the present disclosure, the apparatus further comprises a driving means linked to the second surface for rotating the second surface in the predetermined direction.

In another implementation of the apparatus of the present disclosure, the apparatus further comprises at least one heating cartridge connected to the one or both of the first surface and second surface.

In another implementation of the apparatus of the present disclosure, the apparatus further comprises an ultrasonic and/or low frequency transducer connected to one or both of the first surface and the second surface to apply ultrasonic and/or low frequency vibrations into the substances being mixed at the gap.

In another implementation of the apparatus of the present disclosure, at least one of the first profile or second profile includes an airfoil or hydrofoil profile.

In another implementation of the apparatus of the present disclosure, the apparatus further includes air injection lines in communication with the mixing gap to promote cavitation on the substances flowing through the gap.

In another implementation of the apparatus of the present disclosure, the first profile of the first surface includes first set of structures that project into the mixing gap and mate with grooves formed in the second profile which form interdigitations in the mixing gap.

In another implementation of the apparatus of the present disclosure, the apparatus further comprises at least one electrode pair connected to the first surface and the second surface, that generate an electric field between the first surface and the second surface.

In another implementation of the apparatus of the present disclosure, the second surface is coaxial to the first surface.

In another implementation of the apparatus of the present disclosure, the second surface is co-planar to the first surface.

In another implementation of the apparatus of the present disclosure, the two or more substances is a liquid and a solid, and the mixed blend is a homogeneous blend of the solids suspended in the liquid.

In another implementation of the apparatus of the present disclosure, the two or more substances is a liquid/paste and another liquid/paste and/or a liquid and a gas such as air and the mixed blend is a homogeneous blend of mixed substances.

In another implementation, the present disclosure is of a method of mixing substances into a mixed blend. The method, in one implementation, includes: (a) providing an apparatus of the present disclosure, (b) feeding the two or more substances through the input channel, (c) rotating at least one of the first surface or the second surface while the two or more substances flow through the mixing gap thereby mixing the substances, and (d) collecting the mixed blend.

In another implementation, the present disclosure is of a method of mixing substances into a mixed blend. The method, in one implementation, includes: (a) passing two or more substances through a gap formed by two co-axial surfaces, the two co-axial surfaces having profiles such that the distance between the two co-axial surfaces varies throughout the gap, at least one of the two co-axial surfaces being capable of rotating, (b) rotating at least one of the two co-axial surfaces while the two or more substances pass through the gap thereby mixing the substances, and (c) collecting the mixed blend.

In one implementation of the methods of the present disclosure of mixing substances, the substances include a liquid and particles, and wherein the mixed blend is a homogenous blend of the particles suspended in the liquid.

In another implementation, the present disclosure is a composition, substance, dispersion or compound produced by an apparatus according to an apparatus of the present disclosure.

In one implementation of the present disclosure, the composition, substance, dispersion or compound is a homogenous blend of particles suspended in a liquid.

### BRIEF DESCRIPTION OF THE SEVERAL VIEWS OF THE DRAWINGS

The accompanying drawings, which are incorporated into and form a part of the specification, illustrate implementations of the present disclosure and, together with the description, serve to explain the principles of the disclosure. The drawings are only for the purpose of illustrating one or more preferred implementations of the disclosure and are not to be construed as limiting the disclosure. In the drawings:

FIG. 1 is a schematic diagram of a typical couette having concentric cylinders.

FIG. 2 is a schematic diagram of two co-axial, parallel discs.

FIG. 3 is a schematic diagram of two co-axial cones.

FIG. 4 is a schematic diagram of an apparatus according to one implementation of the present disclosure.

FIG. 5 is a schematic diagram of an apparatus according to another implementation of the present disclosure.

FIG. 6 is a schematic diagram of an apparatus according to another implementation of the present disclosure. FIG. 6A illustrates a pattern of profiles which were constructed on a flat rotating mixing disk. FIG. 6B illustrates an assembly of the disk of FIG. 6A connected to another rotating top disk with a gap in between the two discs. FIG. 6C shows the cross section of disk assembly which is shown in FIG. 6B.

FIG. 7 is a schematic diagram of an apparatus according to another implementation of the present disclosure.

FIG. 8 is a schematic diagram of an apparatus according to another implementation of the present disclosure.

FIG. 9 is a schematic diagram of an apparatus according to another implementation of the present disclosure.

FIG. 10 is a schematic diagram of an apparatus according to another implementation of the present disclosure.

FIG. 11 is a schematic diagram of an apparatus according to another implementation of the present disclosure.

FIG. 12 is a schematic diagram of an apparatus according to another implementation of the present disclosure.

FIG. 13 is a schematic diagram of an apparatus according to another implementation of the present disclosure.

FIG. 14 is a schematic diagram of an apparatus according to another implementation of the present disclosure.

FIG. 15 is a schematic diagram of an apparatus according to another implementation of the present disclosure.

FIG. 16 is a schematic diagram of an apparatus according to another implementation of the present disclosure.

FIGS. 17A-17B provide an illustration of the quality of dispersion obtained using an apparatus according to one implementation of the present disclosure (17B) compared to the high shear mixing (17A) using Carbon Nano Tubes (CNTs) and Liquid Silicone Rubber (LSR) matrix having a viscosity of 1500 cP.

FIGS. 18A-18B provide an illustration of the quality of dispersion obtained with an apparatus according to one implementation of the present disclosure (18B) compared to the high shear mixing (18A) using CNTs and LSR matrix having a viscosity of 600 cP.

FIGS. 19A-19B provide an illustration of the quality of dispersion obtained by an apparatus according to one implementation of the present disclosure (19B) compared to the high shear mixing (19A) using CNTs and paraffinic process oil having a viscosity of 300 cP.

FIGS. 20A-20D provide optical images of the dispersion of CNTs in an epoxy resin, (20A): the sample prepared using high shear mixing at 100× magnification, (20B): the sample prepared using high shear mixing at 1000× magnification, (20C): the sample prepared using an apparatus according to one implementation of the present disclosure at 100× magnification, and (20D): the sample prepared using an apparatus according to one implementation of the present disclosure at 1000× magnification.

FIGS. 21A-21B provide optical images of the dispersion of CNTs in a vinyl group-terminated polysiloxanes resin, (21A): the sample prepared using high shear mixing at 100× magnification, and (21B): the sample prepared using an apparatus according to one implementation of the present disclosure at 100× magnification.

FIGS. 22A-22B provide optical images of the dispersion of CNTs in a high viscosity epoxy resin, (22A): the sample prepared using a Hockmeyer immersion mill at 100× magnification, and (22B): the sample prepared using an apparatus according to one implementation of the present disclosure at 100× magnification.

FIG. 23 provides an illustration of comparison of percolation thresholds of CNTs in silicone rubber composite samples formulated using masterbatches prepared by high shear mixing and an apparatus according to one implementation of the present disclosure.

FIG. 24 provides an illustration of percolation threshold of CNTs in epoxy composite samples formulated using a masterbatch prepared by an apparatus according to one implementation of the present disclosure.

FIG. 25 provides an illustration of percolation threshold of CNTs in EPDM rubber composite samples formulated using a masterbatch prepared by an apparatus according to one implementation of the present disclosure.

### DETAILED DESCRIPTION

### Definitions

Unless defined otherwise, all technical and scientific terms used herein have the same meaning as commonly understood by one of ordinary skill in the art to which this disclosure belongs. Also, unless indicated otherwise, except within the claims, the use of “or” includes “and” and vice versa. Non-limiting terms are not to be construed as limiting unless expressly stated or the context clearly indicates otherwise (for example “including,” “having” and “comprising” typically indicate “including without limitation”). Singular forms included in the claims such as “a,” “an” and “the” include the plural reference unless expressly stated otherwise. All relevant references, including patents, patent applications; government publications, government regulations, and academic literature are hereinafter detailed and incorporated by reference in their entireties. In order to aid in the understanding and preparation of the within disclosure, the following illustrative, non-limiting, examples are provided.

For the purposes of this specification and appended claims, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some implementations, ±100% in some implementations ±50%, in some implementations ±20%, in some implementations ±10%, in some implementations ±5%, in some implementations ±1%, in some implementations ±0.5%, and in some implementations ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

The term “substantially,” when used in this document, includes exactly the term it modifies and slight variations therefrom. Thus, the term “substantially planar” or “planar” means exactly a planar shape and slight variations therefrom.

For purposes of the specification and claims, the term “particles” as generally used herein includes spherical particles (e.g., droplets), fibers (e.g., filaments, ligaments, etc.), flakes (e.g., graphite, clay particles) and other similar shapes made from any suitable solid (e.g., fumed silica), liquid (e.g., polymer melts, etc.) which may solidify, evaporate, and/or remain in liquid form and gas (e.g., Nitrogen gas).

For the purposes of the specification and the claims, the substance(s) that can be mixed in the apparatus of the present disclosure include(s) solid particles, solid particle mixtures, pure liquids, liquid mixtures, liquids in supercritical stage (e.g., supercritical CO₂), gases, gas mixtures, liquid aerosol such as mist, solid aerosol like smoke, foams, emulsions, suspensions, colloids, molten glass, molten metals, molten salts, sols (pigmented particles in liquids), solid forms like aerogel, and gels. The particles in the substance(s) can be nanoparticles.

### Overview

Various apparatuses, processes, and methods will be described below to demonstrate examples of implementations for the claimed disclosure. No implementation described below limits any claimed disclosure and any claimed disclosure may cover processes or apparatuses that differ from those described below. The claimed disclosure is not limited to apparatuses, processes and methods having all of the features of any one apparatus or process described below or to features common to multiple or all of the apparatuses described below. It is possible that an apparatus or process described below is not an implementation of any claimed disclosure. Any disclosure disclosed below that is not claimed in this document may be the subject matter of another protective instrument, for example, a continuing patent application, and the applicants, inventors or owners do not intend to abandon, disclaim or dedicate to the public any such disclosure by its disclosure in this document.

Complete dispersion of particles, especially nanoparticles, is usually performed in a liquid phase applying very high shear stresses using shear-mixing and/or sonication. These processes are both governed by the transfer of high local shear stresses on particle aggregates which breaks down the aggregates. Complete dispersion of particles would require the shear energy densities delivered to the cluster of particles to exceed their binding energy arising from Van der Waals forces between the particles. Although the state of particle separation achieved may only be temporary, it significantly assists the surface adsorption of interfacial molecules such as surfactants, coupling agents and/or compliant solvent molecules which may subsequently stabilize the dispersion. During mixing and dispersion, the level of energy density required to break the particle agglomeration is proportional to the applied shear stress on particle clusters. Shear stress (σ) is defined as the product of fluid viscosity (η) and fluid strain rate (\dot{γ}), i.e., a σ=η\dot{γ}.

Mechanical shear-mixing through stirring or extrusion can be performed in both low viscosity liquids (e.g., water or organic solvents such as N-Methyl-2-pyrrolidone, NMP), or highly viscous polymer solutions or melts. Hence, the viscosity values employed in shear mixing can range from low viscous (e.g., 0.001 Pa·s) to very high viscous (e.g., 10000 Pa·s).

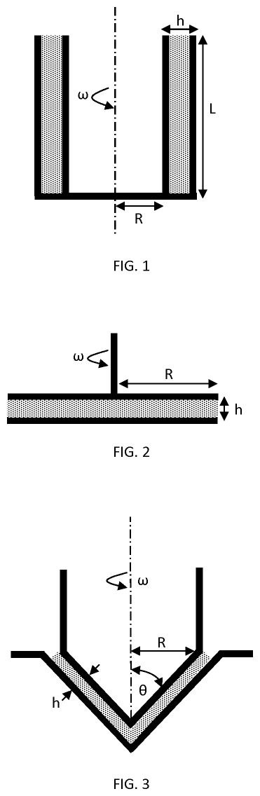

The fluid strain rate (\dot{γ}) for a common shear mixing apparatus is dependent on the rotational speed of the mixing blade (ω rad/s), and the geometry of the mixer and the container. For a typical couette (concentric cylinders, see FIG. 1), strain rate is given by \dot{γ}=Rω/h , with R being the radius of the container which is at stationary, and h the spacing between the leading edge of the mixer blade which is rotating and the inner wall of the container. The standard couette mixing conditions in have yielded a strain rate of 500 s⁻¹; mixing apparatus of different geometries could obtain a fluid strain rate upwards of 10,000 s⁻¹ [1]. The total torque (T) generates by couette system is given by \dot{T}=2πηωR³L/h.

Similar to a couette, as shown in FIG. 2, the maximum strain rate (\dot{γ}) which exerts on fluid by two co-axial parallel disks with R being the radius of disks and one disk is being rotating and the other is stationary is given by \dot{γ}=Rω/h. The total torque (T) generates by parallel disk system is given by \dot{T}=πηωR⁴/2h.

Similarly, as shown in FIG. 3, the maximum strain rate (\dot{γ}) which exerts on fluid by two co-axial cones with R being the radius of base of cone and one cone is being rotating and the other is stationary is given by \dot{γ}=Rω/h. The total torque (T) generates by the system is given by \dot{T}=πηωR⁴/2h sin(θ).

Using a viscous polymer, polymer solution, and/or melt such as epoxy, polystyrene, and/or polypropylene melt (η=10 Pas) and a mixer which can produce a strain rate of 5000 s⁻¹, the shear stress imparted by the mixing medium is around 50 kPa (using the equation σ=η\dot{γ}). Similarly, using the same mixer for low viscosity solvent (η=0.001 Pas), the shear stress delivered to the particle clusters will drop down to 5 Pa, with little expectation of achieving particle dispersion in the solvent.

Compared to mechanical shear mixing, ultrasonication uses a very different physics/mechanism in imparting the shear stress for dispersing agglomerates. Cavitation generally occurs in low-viscosity liquids above a certain ultrasonic energy intensity in the low-pressure regions of the travelling wave. Once created, the cavitation bubbles collapse causing an extremely high strain rate in the liquid close to the regions of bubble implosion.

Strain rates of up to 10⁹ s⁻¹ is produced [2, 3]. In the case of ultrasonication, in typical low viscosity liquids/solvents (η=0.001 Pas), the localized shear stress imparted in the vicinity of an imploding bubble can approach 10⁶ Pa.

### The Apparatus

As described in previous sections, the present disclosure uses high shear, cavitation, and impacting forces to mix and disperse a substance in another substance.

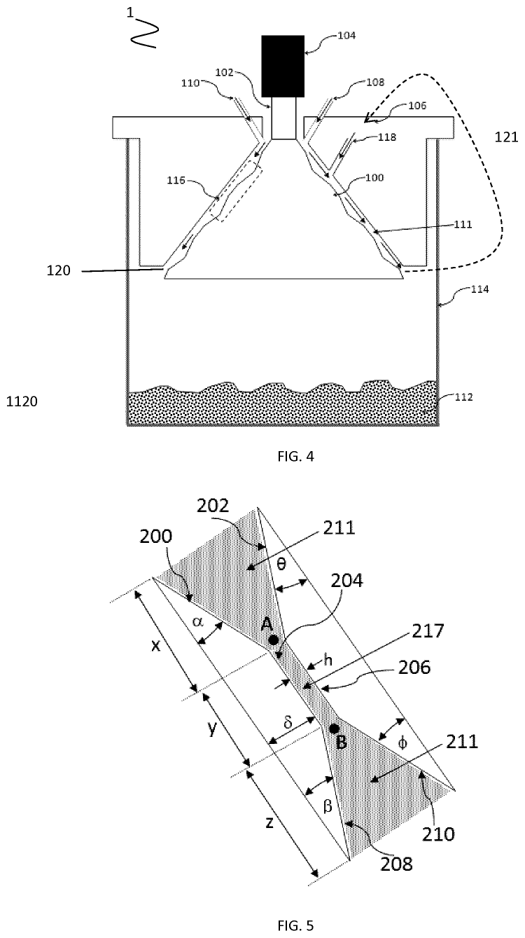

Referring to FIG. 4, there is shown an apparatus 1 for mixing and dispersing one or multiple substances in another substance. The apparatus comprises a first or inner rotating surface 100 that is rotated on a shaft 102 by a motor 104. In addition, the apparatus comprises another second or outer surface 106 which is co-axial to the rotating surface 100. Relative to the first surface 100, the second surface 106 can either be stationary or rotating in the same direction or reverse direction at the same speed or different speed. The space formed between the two surfaces 100, 106 is referred to as a mixing gap or channel 111. Surfaces 100 and 106 can be designed to have profiles 116 on their surfaces which help effectively to mix and disperse the substances together using high shear, cavitation, and impacting forces. The apparatus has singular or plurality of channels (e.g., 108 and 110) to feed the input, raw or untreated material (substances) to be mixed into the mixing gap 111. The material feeding channels can be at the same level like 108 and 110 and/or at different levels like 108 and 118. The mixing gap or channel 111 ends at output opening 120. Finally, the well dispersed mixture 112 reaches the output opening 120 and is collected in the collector (container) 114.

The rotating and/or stationary surfaces 100 and 106 may be of various shapes. For example, the surfaces 100 and 106 may be flat such as a disc or have alternative curved surfaces such as in the shape of a parabola, circle, half-circle, ellipse, hyperbola, and/or combinations thereof.

The surfaces 100 and 106 can be constructed using different materials including but not limited to metals (e.g., aluminum, steel, stainless steel), plastics (e.g., PEEK, Nylon), ceramics (e.g., silicon nitride, aluminum nitride), and carbon (e.g., graphite).

According to some implementations, the input material can feed into the system/apparatus at atmospheric pressure using an open air system and/or pressurized closed system using a pump and/or various other systems.

Referring to FIG. 5, it is shown the repeating profile on surfaces 100 and 106 in FIG. 4. The input material (substances) passes through the mixing gap 211 in between surfaces 200, 202; 204, 206; and 208, 210. In this implementation, the surfaces 200, 202, 204, 206, 208, and 210 can have linear or curved surfaces. In addition, different mixing conditions can achieve by designing profiles 200, 202, 204, 206, 208, and 210 by varying dimensions of x, y, z, α, β, γ, δ, θ, ϕ, and h.

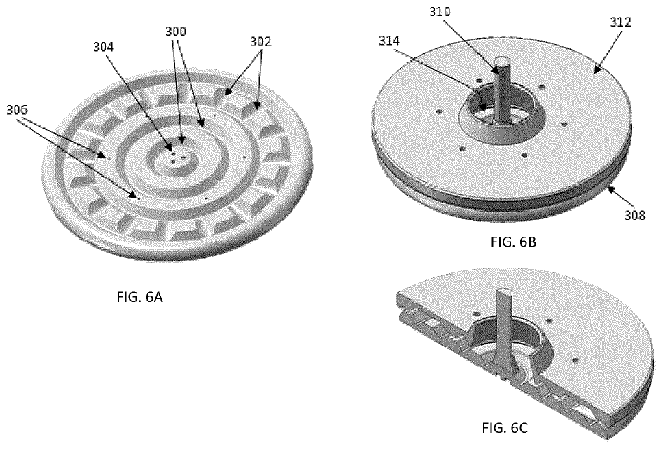

FIG. 6A, illustrates a pattern of profiles which were constructed on a flat rotating mixing disk (308 in FIG. 6B). As shown, the pattern of profiles can be constructed radially (300), circularly (302) and/or combinations thereof. Holes (304) are screw holes to connect the disk to a shaft (310 in FIG. 6B) which is connected to a rotating device (e.g., motor). Holes (306) are screw holes to connect the disk to another rotating top disk (312 in FIG. 6B) with a gap in between the two discs as described in some implementations as the mixing gap 111. However, the disk may be connected to another rotating top disk or to a shaft by means other than screws. The gap between the two discs may vary between about 0.001 mm (=1 um) to about 5 mm and any ranges therein. For example, the mixing gap may be 0.001 mm, 0.005 mm, 0.01 mm, 0.05 mm, 0.1 mm, 0.5 mm, 1 mm, 1.5 mm, 2 mm, 2.5 mm, 3 mm, 3.5 mm, 4 mm, 4.5 mm and ranges therein between. In certain implementations the gap may be smaller than 0.001 mm or larger than 5 mm. As shown in FIG. 6B, the cavity (314) is designed to inject the materials to be mixed. FIG. 6C shows the cross section of disk assembly which is shown in FIG. 6B. According to some implementations, the mixing can be conduct completely immersing the disk assembly in the mixture in a container. In this case, when the disk assembly rotates, the mixture will pull into the cavity (314 in FIG. 6B) and go through the mixing gap in between two disks due to the centrifugal forces. The process repeats until it stops the rotation.

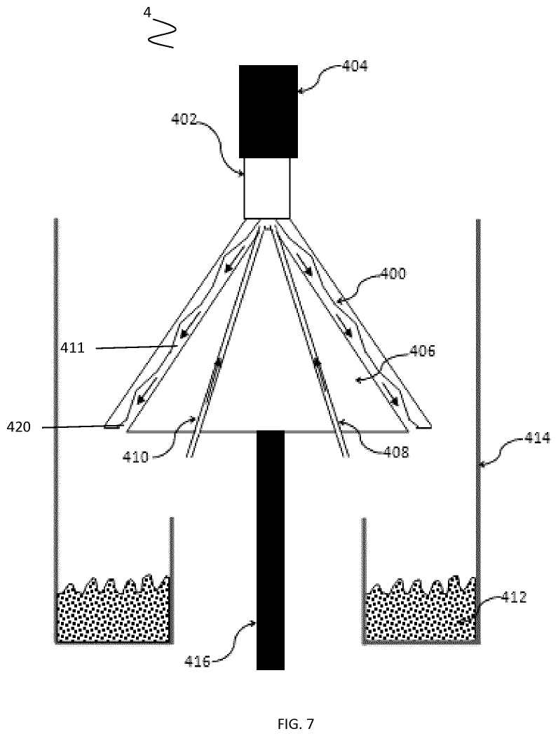

As shown in FIG. 4, compound 112, which could be a homogenous blend of particles suspended in a liquid, is formed from a substance A which is injected or poured into the mixing gap 111 using channel 108 and substance B which is injected or poured into the mixing gap 111 using channel 110. The apparatus and the systems which described in this disclosure then mixes and/or disperse substance A in substance B or vice-versa as they travel through the mixing gap 111 and reach the output opening 120, from where the compound 112 is re-circulated for another cycle of mixing through the apparatus 1, or collected in container 114. As such, in one implementation, the apparatus 1 can include a conduit 121 that connects output 120 with input channels 108 and/or 110. Although not shown, the same conduit can be enabled in an apparatus according to any of the implementations of the present disclosure, including FIGS. 7 to 14 and 16. Alternatively, the compound collected in container 114 can be poured into input channels 108 and/or 110. In addition, substance A and B can be at room temperature, elevated temperature (higher than room temperature), and/or temperature below the room temperature.

The apparatus and system of the present disclosure is used to produce nano and/or micro compounds/composite/colloids where nano and/or micro particles or mixture of particles dispersed in polymers and/or liquids. Micro and nano particles can be defined as particles which have at least one dimension in nano and/or micro scale (e.g., particles which have all three dimensions in the nano/micro scale; fibers, tubes, and wires which have two dimensions in the nano/micro scale; and platelets, flakes, and films which have one dimension in the nano/micro scale). For example, a nanoparticle includes a particle having a diameter of less than approximately 100 nm.

According to some implementations, dispersion can be obtained by allowing mixture of substances A and B to form a material layer in between the rotating surface 100 and stationary or rotating surface 106.

The rotating surfaces 100 and the surface 106 (which could also be made to rotate) induce a centrifugal force on the mixture and this self-pumping action allows the material mixture to travel through the gap 111 in between surfaces 100 and 106.

According to some implementations, traveling mixture enters into the gap 111 between profiles 116 on surfaces 100 and 106. The enlarged version of the profile 116 is shown in FIG. 5. As shown in FIG. 5, firstly, the entered mixture moves along surfaces 200 and 202 due to the centrifugal force acting on the material mixture/compound/composite. As the mixture moves towards a narrowing portion of the gap 211, the velocity of the mixture increases and pressure decreases progressively according to the Bernoulli's theorem. The increasing in velocity of the mixture greatly increases the shearing action on the fluid which assist the dispersion and mixing action among the substances in the mixture/compound/composite. The path of the moving mixture between surfaces 200 and 202 hence the dispersion/mixing is controlled by the parameters x, α, θ and the gap between the surfaces. According to some implementations, the mixture/compound/composite then moves towards point A (see FIG. 5) where it enters into a narrow gap 217 between the surfaces 204 and 206. Before entering into the narrow gap 217 in between the surfaces 204 and 206, the mixture/compound streams moving along the surfaces 200 and 202 collide/impact each other at location A at very high velocities. The force of impact allows them to also effectively reduce particle size, disperse, and mix effectively. These impacting forces can be controlled by optimizing the parameters x, a, and θ.

According to some implementations, the mixture/compound/composite enter into the narrow gap 217 between surfaces 204 and 206 and travel through gap 217 at very high velocities. According to Bernoulli's theorem, high speed moving mixture/compound/composite in this section subjects to very high shear stresses greatly assisting the dispersion, distribution, and mixing of the material. In addition, very low pressures, which generate in the section, may produce cavitation hence shock waves resulting effective dispersion, distribution, and mixing. The shear stresses and cavitation generate in the section can effectively be controlled by changing the parameters h (gap between the surfaces 204 and 206) and length of the section y.

According to some implementations, the mixture/compound/composite arrive near point B as shown in FIG. 5. At point B, the centrifugal force exert on the mixture/compound/composite by rotating surfaces 208 and 210 tear apart the mixture as the centrifugal force generated by the rotating surface 208 is in different/opposite direction compared to the force generated by the rotating/stationary surface 210. In some implementations, the profiles can be designed to generate forces in completely opposite direction (180⁰). The tearing action produce very high shear stresses on the mixture/compound/composite and hence effectively disperse the particles/fillers in the mixture into nano and micro scale. The generated shear stresses can be controlled by changing the parameters β and ϕ.

According to some implementations, the mixture/compound/composite subsequently travel through the surfaces 208 and 210 and the design of the profile such a way that the tearing action continually on the mixture further dispersing, mixing, and promoting the mass transfer between the phases. The mixing and dispersion in this section can be controlled by using the parameters z, β and ϕ.

In addition to the parameters x, y, z, α, β, γ, δ, θ, ϕ, and h, the rotation speed of the disks (e.g., from 10 rpm to 50000 rpm) and viscosity of the mixture (e.g., from 1 cP to 5 million cP) can be used to control the efficiency of the dispersion.

Referring to FIG. 4, there are repeating profile of 116 (e.g., surfaces like 200, 202, 204, 206, 208, and 210) along the surfaces 100 and/or 106. Therefore, the mixing and dispersing actions of impacting, shearing, cavitating, and/or splitting continually take place in the apparatus along the surfaces 100 and 106.

According to some implementations, the mixture can be re-circulated through the apparatus to increase the mixing time for improved mixing.

Referring to FIG. 7, according to some implementations, there is shown an apparatus 4 for mixing and dispersing one or multiple substances in another substance. The apparatus comprises outer or second rotating surface 400 that is rotated on a shaft 402 by a motor 404. In addition, the apparatus comprises another first or inner surface, 406 which is co-axial to the rotating surface 400. The surface 406 is a stationary surface. Surfaces 400 and 406 are designed to have profiles similar to profiles 116 in FIG. 4 on their surfaces which help effectively to mix, distribute, and disperse the substances together using the forces of high shear, cavitation, and impacting. The apparatus has channels 408 and 410 to feed the material (substances) into the mixing gap or channel 411 formed between the second surface 400 and the first surface 406. The dispersed mixture exists the mixing gap 411 at output opening 420. The well dispersed mixture, 412 is collected in the collector (container) 414. The structure 416 is designed to hold the stationary surface 406.

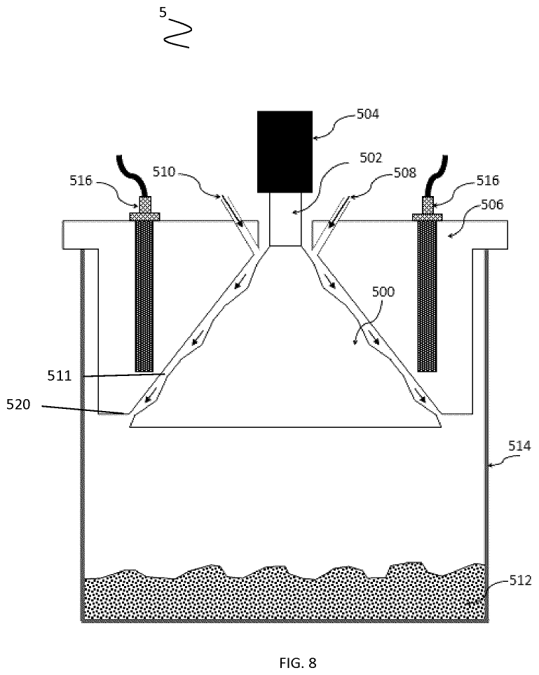

Referring to FIG. 8, according to some implementations, there is shown an apparatus 5 for mixing and dispersing one or multiple substances in another substance. The apparatus comprises an inner or first rotating surface 500 that is rotated on a shaft 502 by a motor 504. In addition, the apparatus comprises another outer or second stationary surface 506 which is co-axial to the rotating surface 500. Surfaces 500 and 506 are designed to have profiles similar to 116 on their surfaces which help effectively to mix, distribute, and disperse the substances together using the forces of high shear, cavitation, and impacting. The apparatus has channels 508 and 510 to feed the material (substances) into the mixing gap or channel 511 formed between the first surface 500 and the second surface 506. The dispersed mixture exists the mixing gap 511 at output opening 520. The well dispersed mixture, 512 is collected in the collector (container) 514. Singular or plurality of heating cartridges 516 are insert into the stationary system to heat the mixture to a required level. This version of the apparatus can be used to process thermoplastic polymer compounds and other high temperature colloids/compounds/composite.

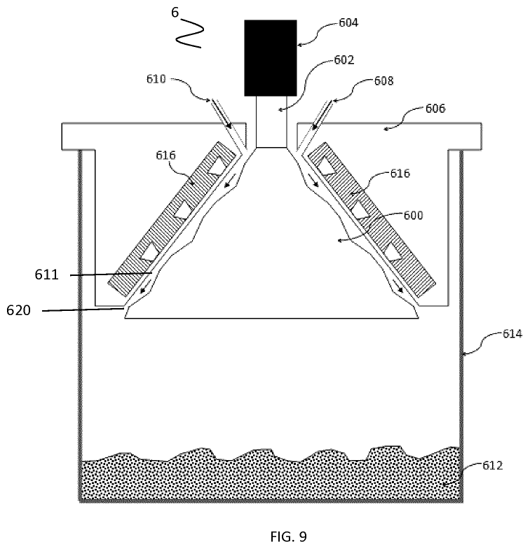

Referring to FIG. 9, according to some implementations, there is shown an apparatus 6 for mixing and dispersing one or multiple substances in another substance. The apparatus comprises an inner or first rotating surface 600 that is rotated on a shaft 602 by a motor 604. In addition, the apparatus comprises another outer or second stationary surface, 606 which is co-axial to the rotating surface 600. Surfaces 600 and 606 are designed to have profiles similar to 116 on their surfaces which help effectively to mix, distribute, and disperse the substances together using the forces of high shear, cavitation, and impacting. The apparatus has channels 608 and 610 to feed the material (substances) into the mixing gap or channel 611 formed between the first surface 600 and the second surface 606. The dispersed mixture exists the mixing gap 611 at output opening 620. The well dispersed mixture, 612 is collected in the collector (container) 614. Singular or plurality of ultrasonic transducers 616 are connected on the stationary surface 606 to apply ultrasonic vibrations into the travelling mixture/compound/composite. Ultrasonic vibration produce cavitation and shock waves which further assist to disperse nano and micro particles/fillers in host matrix.

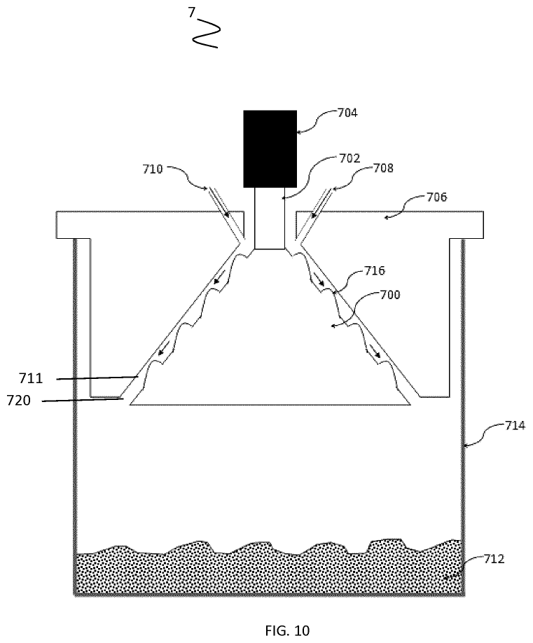

Referring to FIG. 10, according to some implementations, there is shown an apparatus 7 for mixing and dispersing one or multiple substances in another substance. The apparatus comprises an inner or first rotating surface 700 that is rotated on a shaft 702 by a motor 704. In addition, the apparatus comprises another outer or second stationary surface, 706 which is co-axial to the rotating surface 700. Surfaces 700 and 706 are designed to have profiles 716 similar to airfoils/hydrofoils on their surfaces which help effectively to mix, distribute, and disperse the substances together using the forces of high shear, cavitation, and impacting. The apparatus has channels 708 and 710 to feed the material (substances) into the mixing gap or channel 711 formed between the first surface 700 and the second surface 706. The dispersed mixture exists the mixing gap 711 at output opening 720. The well dispersed mixture, 712 is collected in the collector (container) 714. Airfoil/hydrofoil shaped profiles (like 716) can generate very high fluid velocities when the mixture/compound/composite pass through these profiles hence can generate very high shear stresses and produce cavitation resulting improved dispersion and mixing.

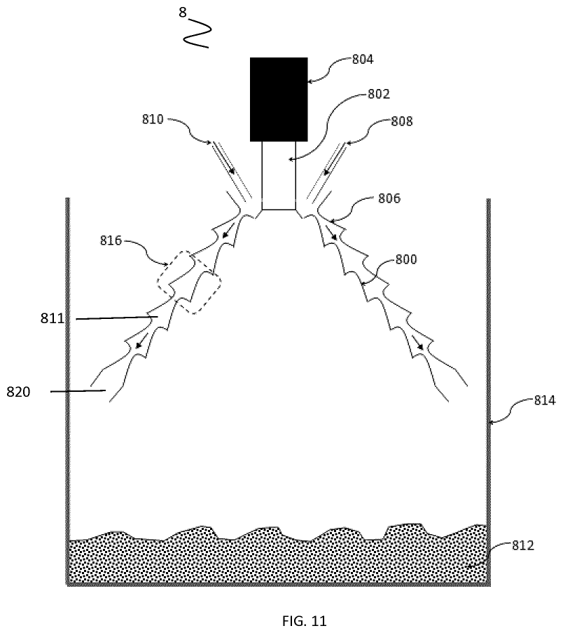

Referring to FIG. 11, according to some implementations, there is shown an apparatus 8 for mixing and dispersing one or multiple substances in another substance. The apparatus comprises an inner or first rotating surface 800 that is rotated on a shaft 802 by a motor 804. In addition, the apparatus comprises another outer or second rotating surface, 806 which is co-axial to the rotating surface 800 and connected to the rotating surface 800. Surfaces 800 and 806 are designed to have profiles 816 similar to airfoils/hydrofoils on their surfaces which help effectively to mix, distribute, and disperse the substances together using the forces of high shear, cavitation, and impacting. The apparatus has channels 808 and 810 to feed the material (substances) into the mixing gap or channel 811 formed between the first surface 800 and the second surface 806. The dispersed mixture exists the mixing gap 811 at output opening 820. The well dispersed mixture, 812 is collected in the collector (container) 814. Airfoil/hydrofoil shaped profiles (like 816) can generate very high fluid velocities when the mixture/compound/composite pass through these profiles hence can generate very high shear stresses and produce cavitation resulting improved dispersion and mixing.

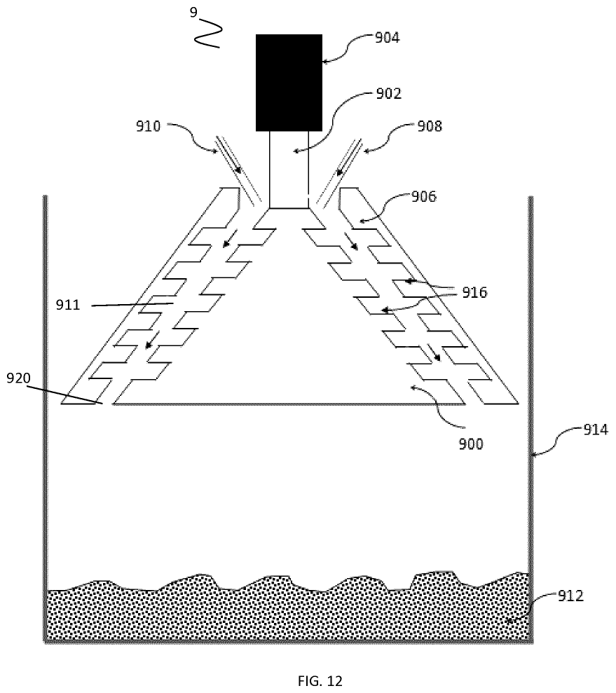

Referring to FIG. 12, according to some implementations, there is shown an apparatus 9 for mixing and dispersing one or multiple substances in another substance. The apparatus comprises an inner or first rotating surface 900 that is rotated on a shaft 902 by a motor 904. In addition, the apparatus comprises another outer or second rotating surface, 906 which is co-axial to the rotating surface 900 and connected to the rotating surface 900. The profiles 916 on rotating surfaces 900 and 906 can generate cavitation effect on the liquid mixture which is flowing through the system. In addition, the profiles 916 can generate very high shear stresses on the mixture/compound/composite attribute to the high angular difference between surfaces (between 90⁰-180⁰). As a result of this high angular difference the mixture split into two high speed streams generating high shear stresses on the particles/fillers in the system resulting effective distribution and dispersion within the matrix material. The apparatus has channels 908 and 910 to feed the material (substances) into the mixing gap or channel 911 formed between the first surface 900 and the second surface 906. The dispersed mixture exists the mixing gap 911 at output opening 920. The well dispersed mixture, 912 is collected in the collector (container) 914.

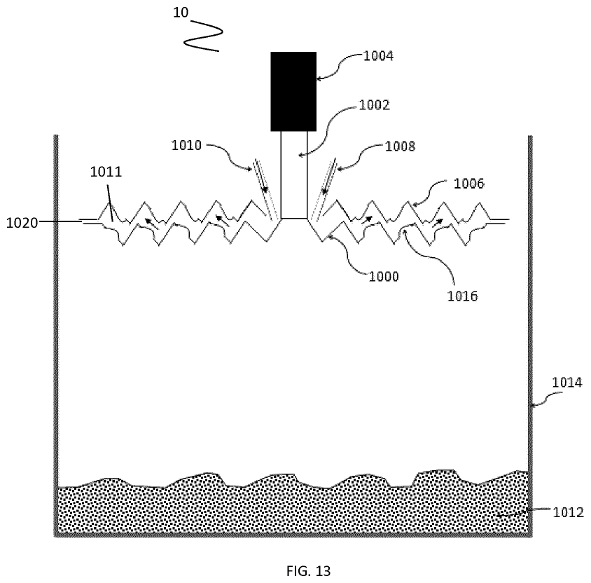

Referring to FIG. 13, according to some implementations, there is shown an apparatus 10 for mixing and dispersing one or multiple substances in another substance. The apparatus comprises a disc-like (bottom or first) rotating surface 1000 that is rotated on a shaft 1002 by a motor 1004. In addition, the apparatus comprises another top or second disc-like rotating surface, 1006 which is co-planar to the rotating surface 1000 and connected to the rotating surface 1000. The plane of the first 1000 and second 1006 surfaces are disposed substantially perpendicular to the shaft 1002. The profiles 1016 on surfaces 1000 and 1006 can generate very high shear stresses on the mixture/compound/composite attribute to the high angular difference between surfaces (around 90⁰) in addition to the airfoil/hydrofoil shaped profiles. As a result of this high angular difference between surfaces, the mixture split into two high speed streams generating high shear stresses on the particles/fillers in the system resulting effective distribution and dispersion within the matrix material. The apparatus has channels 1008 and 1010 to feed the material (substances) into the mixing gap or channel 1011 formed between the first surface 1000 and the second surface 1006. The dispersed mixture exists the mixing gap 1011 at output opening 1020. The well dispersed mixture, 1012 is collected in the collector (container) 1014.

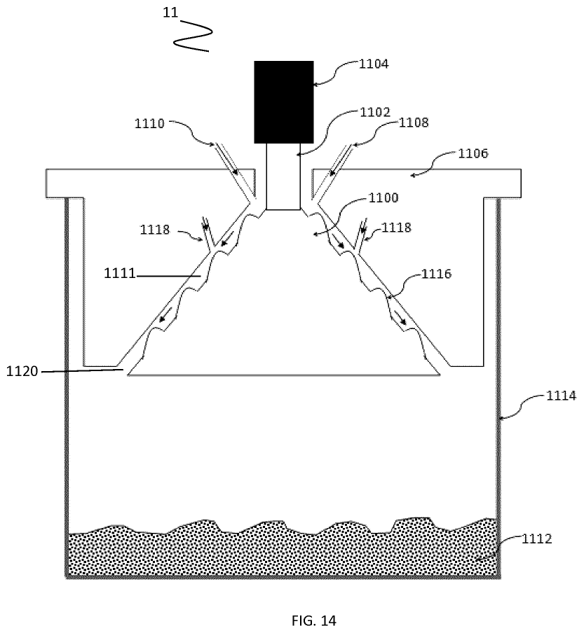

Referring to FIG. 14, according to some implementations, there is shown an apparatus 11 for mixing and dispersing one or multiple substances in another substance. The apparatus comprises inner or first rotating surface 1100 that is rotated on a shaft 1102 by a motor 1104. In addition, the apparatus comprises another outer or second stationary surface 1106 which is co-axial to the rotating surface 1100. Surfaces 1100 and 1106 are designed to have profiles 1116 similar to airfoils/hydrofoils on their surfaces which help effectively to mix, distribute, and disperse the substances together using the forces of high shear, cavitation, and impacting. The apparatus has air (at atmospheric pressure, above atmospheric pressure and/or below atmospheric pressure) injection lines/nozzles 1118 at various locations around the circumference of the surface 1106 to promote the cavitation effect in the fluid mixture. More specifically, these air lines/nozzles are placed at locations where the cavitation effect is greatly dominant. The apparatus has channels 1108 and 1110 to feed the material (substances) into the mixing gap or channel 1111 formed between the first surface 1100 and the second surface 1106. The dispersed mixture exists the mixing gap 1111 at output opening 1120. The well dispersed mixture, 1112 is collected in the collector (container) 1114.

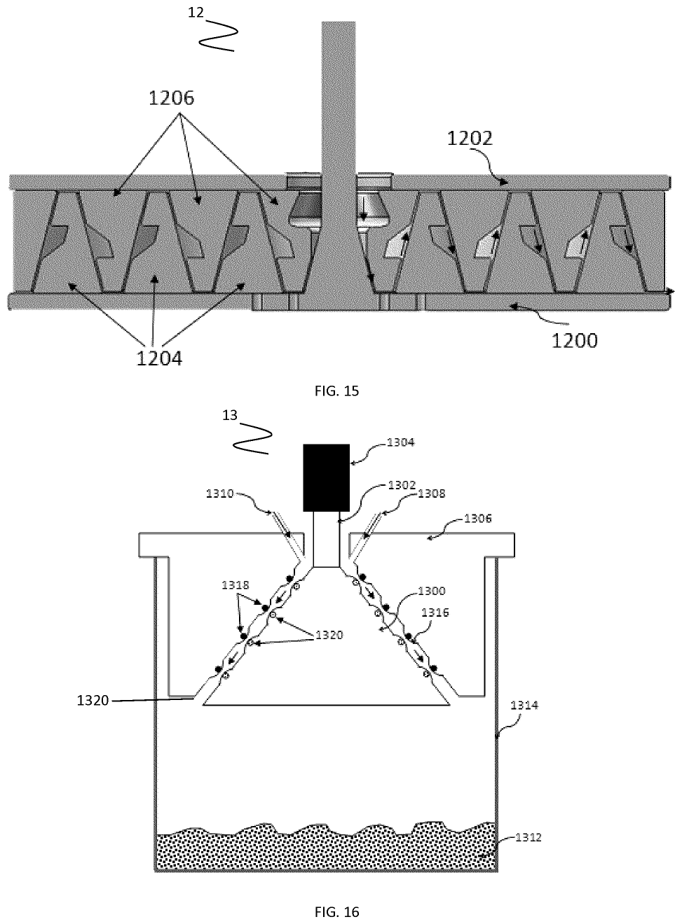

Referring to FIG. 15, according to some implementations, there is shown an apparatus/device 12 for mixing and dispersing one or multiple substances in another substance. The apparatus comprises rotating disks 1200 with structures 1204 and 1202 with structure 1206. As shown in FIG. 15 (see arrows), the mixture/compound/composite pass through the gaps and profiles in between 1200, 1202, 1204, and 1206. An arrangement similar to this can be used to increase the mixing time by increasing the length of the path that mixture/compound/composite travels subjecting to mixing forces of impacting, shearing, and cavitating.

Referring to FIG. 16, according to some implementations, there is shown an apparatus 13 for mixing and dispersing one or multiple substances in another substance. The apparatus comprises an inner or first rotating surface 1300 that is rotated on a shaft 1302 by a motor 1304. In addition, the apparatus comprises another outer or second stationary surface, 1306 which is co-axial to the rotating surface 1300. There are electrodes 1318 and 1320 are connected on profiles 1316 on surfaces 1300 and 1306. Uniform and/or non-uniform electric filed can be generated between the electrodes 1318 and 1320 by applying a high voltage including DC high voltage (positive or negative), AC high voltage, high voltage pulse at a specified frequency, and/or high voltage pulse at varying frequencies. In addition to the improved mixing and/or dispersion, the electric field assists including but not limited to cell lysis, electroporation, electrophoresis, electrical field-induced extraction and separation (e.g., liquid-liquid extraction, electroextraction, waste water treatment) and/or particle/filler alignment. The apparatus has channels 1308 and 1310 to feed the material (substances) into the mixing gap or channel 1311 formed between the first surface 1300 and the second surface 1306. The dispersed mixture exists the mixing gap 1311 at output opening 1320. The well dispersed mixture, 1312 is collected in the collector (container) 1314.

The following examples are offered for illustrative purposes only, and are not intended to limit the scope of the present disclosure in any way. Indeed, various modifications of the disclosure in addition to those shown and described herein will become apparent to those skilled in the art from the foregoing description and the following examples and fall within the scope of the appended claims.

The following examples demonstrate the dispersion effectiveness of the apparatus and method of the present disclosure. Results with the present disclosure are compared to conventional industry grade dispersion technique, high shear mixing (Ross-100LSK) and/or milling (Hockmeyer lab scale immersion mill).

### EXAMPLE 1

1 wt % of concentration of high aspect ratio Multi-Wall Carbon Nano Tubes (MWCNTs) with diameter less than 15 nm and length greater than 50 um were dispersed in silicone rubber matrix having a viscosity around 1500 cP (1) using the implementation of the apparatus of present disclosure which is shown in FIG. 13 with the disks illustrated in FIG. 6B with a gap of 1 mm, and (2) using a high shear mixer, Ross-100LSK. The sample size was 500 g and mixing time was 2 mins. The rotation speed of the apparatus of the present disclosure and Ross high shear mixer 7500 rpm and 10,000 rpm respectively. After the dispersion, the quality of dispersion of the resultant mixture was analyzed using the following method.

A small amount of each mixture was re-dispersed in virgin silicone rubber samples having a viscosity of 1500 cP (in a vial) using hand shaking for 30 seconds. As shown in FIG. 17, the sample (FIG. 17B) prepared using the apparatus of present disclosure completely disperse the CNTs in silicone rubber matrix while the sample (FIG. 17A) prepared using the high shear mixing shows non-dispersed large agglomerates in silicone rubber matrix.

As illustrated in FIGS. 17, the Ross-100LSK cannot achieve the level of dispersion quality achieved with the apparatus of the present disclosure even when the apparatus of the present disclosure uses lower rotation speeds. The Ross-100LSK cannot achieve the quality of dispersion that the present disclosure's apparatus can achieve, even at higher speed and increased mixing time.

### EXAMPLE 2

1 wt % of concentration of high aspect ratio Multi-Wall Carbon Nano Tubes (MWCNTs) with diameter less than 15 nm and length greater than 50 um were dispersed in silicone rubber matrix having a viscosity around 600 cP (1) using the implementation of the apparatus of present disclosure which is shown in FIG. 13 with the disks illustrated in FIG. 6B, and (2) using a high shear mixer, Ross-100LSK. The sample size was 500 g and mixing time was 2 mins. The rotation speed of the apparatus of the present disclosure and Ross high shear mixer 7500 rpm and 10,000 rpm respectively. After the dispersion, the quality of dispersion of the resultant mixture was analyzed using the following method. A small amount of each mixture was re-dispersed in virgin silicone rubber samples having a viscosity of 600 cP (in a vial) using hand shaking for 30 seconds. As shown in FIGS. 18A-18B, the sample (FIG. 18B) prepared using the apparatus of present disclosure completely disperse the CNTs in silicone rubber matrix while the sample (FIG. 18A) prepared using the high shear mixing shows non-dispersed large agglomerates in silicone rubber matrix.

### EXAMPLE 3

1wt % of concentration of high aspect ratio Multi-Wall Carbon Nano Tubes (MWCNTs) with diameter less than 15 nm and length greater than 50 um were dispersed in paraffinic process oil having a viscosity around 300 cP (1) using the implementation of the apparatus of present disclosure which is shown in FIG. 13 with the disks illustrated in FIG. 6B, and (2) using a high shear mixer, Ross-100LSK. The sample size was 500 g and mixing time was 2 mins. The rotation speed of the apparatus of the present disclosure and Ross high shear mixer 7500 rpm and 10,000 rpm respectively. After the dispersion, the quality of dispersion of the resultant mixture was analyzed using the following method. A small amount of each mixture was re-dispersed in virgin paraffinic process oil samples having a viscosity of 300 cP (in a vial) using hand shaking for 30 seconds. As shown in FIGS. 19A-19B, the sample (FIG. 19B) prepared using the apparatus of present disclosure completely disperse the CNTs in paraffinic process oil while the sample (FIG. 19A) prepared using the high shear mixing shows non-dispersed large agglomerates in paraffinic process oil.

### EXAMPLE 4

1wt % of concentration of high aspect ratio Multi-Wall Carbon Nano Tubes (MWCNTs) with diameter less than 15 nm and length greater than 50 um were dispersed in bisphenol A (BPA) epoxy resin (e.g., D.E.R.™ 324) having a viscosity around 700 cP (1) using the implementation of the apparatus of present disclosure which is shown in FIG. 13 with the disks of FIG. 6B, and (2) using a high shear mixer, Ross-100LSK. The sample size was 200 g and mixing time was 2 mins for the apparatus of present disclosure and 10 mins for Ross high shear mixer respectively. The rotation speed of the apparatus of the present disclosure and Ross high shear mixer were 7500 rpm and 10,000 rpm respectively. It was also observed that with the dispersion of carbon nano tubes in the resin, the viscosity increases significantly resulting high shear mixing ineffective. The mixture viscosity does not adversely affect on mixing using the apparatus of the present disclosure, furthermore, in the present apparatus, the increasing viscosity significantly help for further dispersion of nanotubes in the matrix. After the dispersion, the quality of dispersion of the resultant mixture was analyzed using the following method.

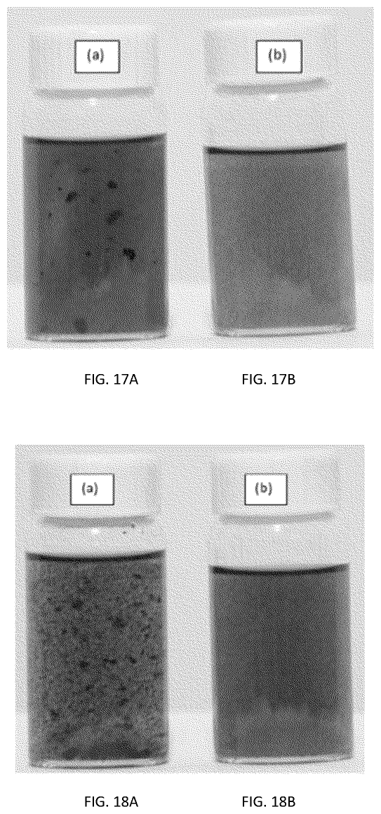

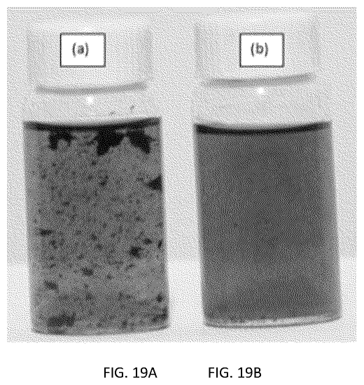

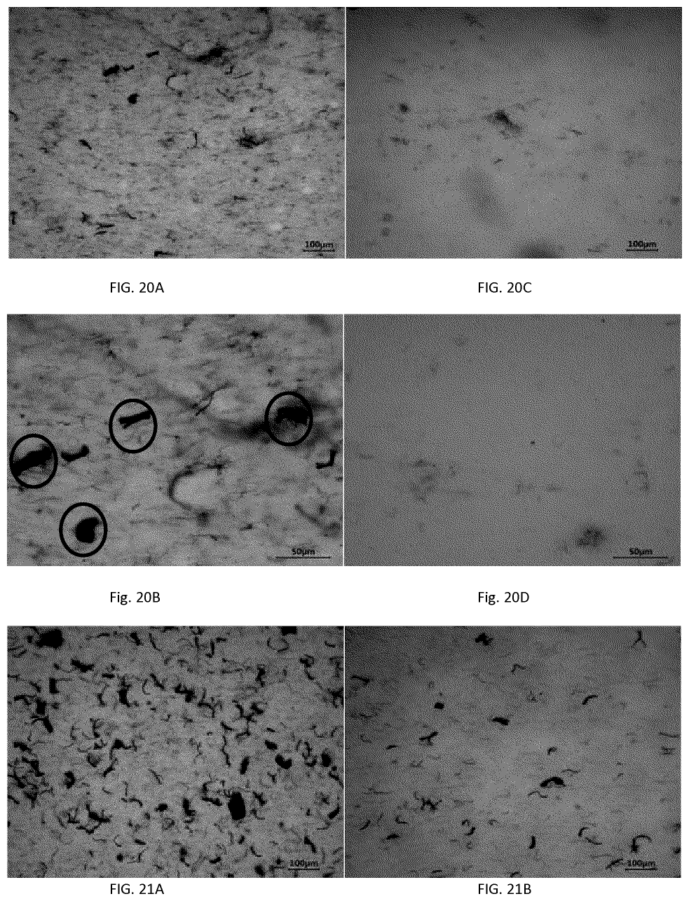

A small amount of each mixture obtained with (1) and (2) was re-dispersed in virgin epoxy resin (e.g., D.E.R.™ 331) having a viscosity of 11000 cP using hand mixing for 30 seconds. Then the samples were investigated under an optical microscope, OMAX digital LED trinocular compound microscope that includes a digital imaging system, at different magnification. As shown in FIGS. 20(c) (magnification: 100×) and 20(d) (magnification: 1000×), the sample prepared using the apparatus of present disclosure shows the complete dispersion of CNTs in the epoxy matrix while the sample prepared using the high shear mixing shows large number of non-dispersed large agglomerates (circled in FIG. 20(b)) in epoxy matrix (see FIGS. 20(a) (magnification: 100×) and 20(b) (magnification: 1000×)).

### EXAMPLE 5

1wt % of concentration of high aspect ratio Multi-Wall Carbon Nano Tubes (MWCNTs) with diameter less than 15 nm and length greater than 50 um were dispersed in vinyl group-terminated polysiloxanes resin (e.g., BLUESIL® 621V1000) having a viscosity around 1000 cP (1) using the implementation of the apparatus of present disclosure which is shown in FIG. 13 with the disks illustrated in FIG. 6B, and (2) using a high shear mixer, Ross-100LSK. The silicone resin is not much compatible with carbon nano tubes and more difficult to disperse compared to epoxy resins. The sample size was 200g and mixing time was 2 mins for the apparatus of present disclosure and 10 mins for Ross high shear mixer respectively. The rotation speed of the apparatus of the present disclosure and Ross high shear mixer 7500 rpm and 10,000 rpm respectively. After the dispersion, the quality of dispersion of the resultant mixture was analyzed using the following method.

A small amount of each mixture obtained with (1) and (2) was re-dispersed in virgin silicone resin (e.g., BLUESIL® 621V5000) having a viscosity of 5000 cP using hand mixing for 30 seconds. Then the samples were investigated under an optical microscope, OMAX digital LED trinocular compound microscope that includes a digital imaging system, at different magnification. As shown in FIG. 21(b) (magnification: 1000×), the sample prepared using the apparatus of present disclosure shows significantly better dispersion of CNTs in silicone matrix while the sample prepared using the high shear mixing shows significantly large number of non-dispersed large agglomerates in silicone matrix (see FIG. 21(a) (magnification: 100×).

### EXAMPLE 6

1wt % of concentration of high aspect ratio Multi-Wall Carbon Nano Tubes (MWCNTs) with diameter less than 15 nm and length greater than 50 um were dispersed in high viscosity bisphenol A (BPA) epoxy resin (e.g., D.E.R.™ 331) having a viscosity around 11000 cP (1) using the implementation of the apparatus of present disclosure which is shown in FIG. 13 with the disks illustrated in FIG. 6B, and (2) using a Hockmeyer lab scale immersion mill which is suitable for high viscosity liquid dispersion. The sample size was 1000g and mixing time was 10mins for the apparatus of present disclosure and 30 mins for Hockmeyer immersion mill respectively. The rotation speed of the apparatus of the present disclosure and Hockmeyer immersion mill were 7500 rpm and 5000 rpm (maximum possible) respectively. After the dispersion, the quality of dispersion of the resultant mixture was analyzed using the following method.

A small amount of each mixture obtained with (1) and (2) was re-dispersed in virgin epoxy resin (e.g., D.E.R.™ 331) having a viscosity of 11000 cP using hand mixing for 30 seconds. Then the samples were investigated under an optical microscope, OMAX digital LED trinocular compound microscope that includes a digital imaging system, at different magnification. As shown in FIG. 22(b) (magnification: 100×), the sample prepared using the apparatus of present disclosure shows the complete dispersion of CNTs in high viscosity epoxy matrix while the sample prepared using the Hockmeyer immersion mill shows large number of non-dispersed large agglomerates in the epoxy matrix (see FIG. 22(a) (magnification: 100×).

### EXAMPLE 7

1wt % of concentration of high aspect ratio Multi-Wall Carbon Nano Tubes (MWCNTs) with diameter less than 15 nm and length greater than 50 um were dispersed in vinyl group-terminated polysiloxanes resin (e.g., BLUESIL® 621V1000) having a viscosity around 1000 cP (1) using the implementation of the apparatus of present disclosure which is shown in FIG. 13 with the disks illustrated in FIG. 6B, and (2) using a high shear mixer,

Ross-100LSK. The sample size was 200 g and mixing time was 2 mins for the apparatus of present disclosure and 10 mins for Ross high shear mixer respectively. The rotation speed of the apparatus of the present disclosure and Ross high shear mixer 7500 rpm and 10,000 rpm respectively. After the dispersion, the electrical conductivity of both samples was analyzed at different concentration of CNTs to investigate the percolation curves.

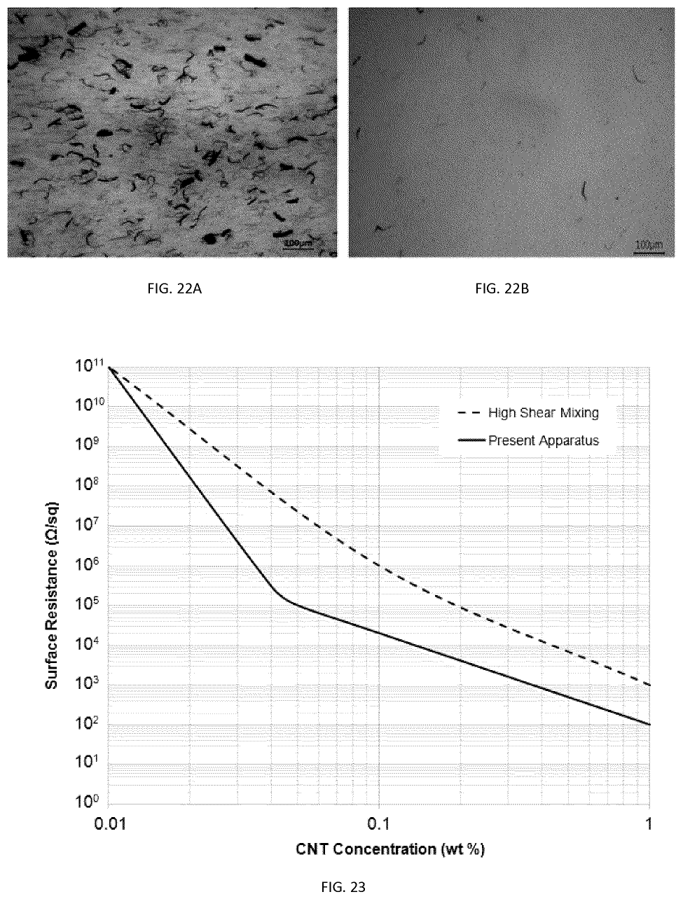

0.01 wt. %, 0.025 wt. %, 0.05 wt. %, 0.1 wt. %, and 0.5 wt. % of experimental CNT/silicone samples (the weight percentages shows the CNT concentration in the sample) were prepared by diluting the 1 wt. % of CNT/silicone sample (masterbatch) prepared using both the mixing methods. SYLGARDTM 184 silicone elastomer from DOW chemical was used to dilute the 1 wt. % of CNT/silicone masterbatches. The dilution was performed by using a simple overhead mixer with high shear blades and rotates at 1500 rpm. Then, the curing agent was added to each sample, and the samples were stirred for 5 minutes. Samples were cured using the obtained blends, poured into aluminum molds, and hot-pressed at 3000 psi and 150° C. for 10 minutes. The thickness of the prepared silicone slabs is 2 mm. The surface resistance of the silicone slabs was measured using OHM-STAT® RT-1000 Megohmmeter and the results were plotted as shown in FIG. 23. As shown in FIG. 23, the samples prepared using the apparatus of present disclosure shows a significantly lower percolation threshold at 0.045 wt. % of CNT while the sample prepared using the high shear mixing shows a percolation threshold at 0.1 wt. % of CNT. This further confirms the superior dispersion of CNTs in the mixture (masterbatch) which was prepared using the apparatus of present disclosure.

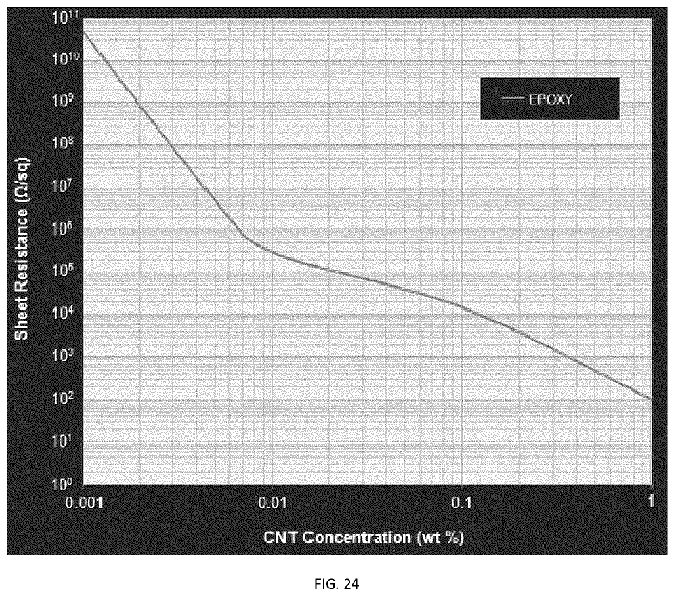

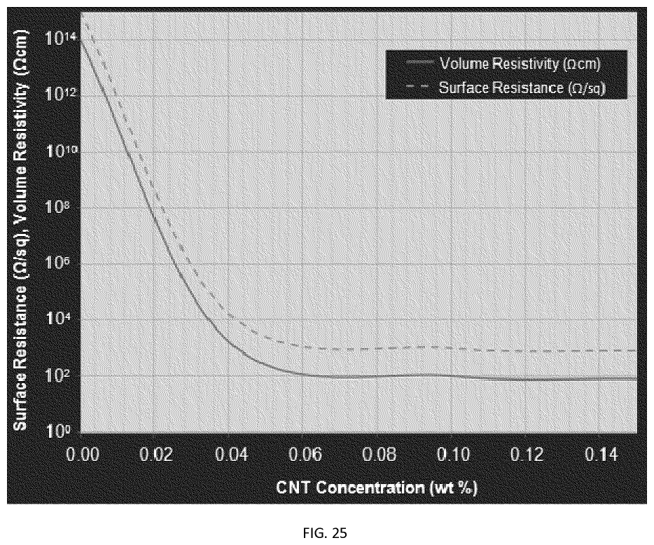

Similarly, very low percolation thresholds can be obtained for different resin systems by using the masterbatches prepared with the apparatus of present disclosure. FIG. 24 shows the percolation curve for an epoxy resin system which was obtained using a 1 wt. % of CNT/epoxy masterbatch prepared using the present apparatus. Similarly, FIG. 25 shows the percolation curve for an EPDM rubber system which was obtained using a 2 wt. % of CNT/paraffinic oil masterbatch prepared using the present apparatus.

Similar masterbatches including epoxy, silicone, paraffinic oil, naphthenic oil, rubber processing oil, thermoplastic processing liquids, acrylic, polyol, polymer solutions (e.g., polyvinylidene difluoride, Polyvinylpyrrolidone, Carboxymethyl cellulose, etc.) but not limited to can be prepared using the apparatus of the present disclosure to achieve very low percolation thresholds.

REFERENCES

[1] Y. Y. Huang and E. M. Terentjev, “Dispersion of Carbon Nanotubes: Mixing, Sonication, Stabilization, and Composite Properties,” Polymers, Issue 4, pages. 275-295, 2012.

[2] T. Q. Nguyen, Q. Z. Liang, and H. H. Kausch, “Kinetics of ultrasonic and transient elongational flow degradation: A comparative study.” Polymer, vol. 38, Issue 15, pages. 3783-3793, 1997.

[3] D. Lohse, “Sonoluminescence-cavitation hots up,” Nature, Issue 434, pages. 33-34, 2005.

Although the disclosure has been described in detail with particular reference to these preferred implementations, other implementations can achieve the same results. Variations and modifications of the present disclosure will be obvious to those skilled in the art and it is intended to cover in the appended claims all such modifications and equivalents. The entire disclosures of all references, applications, patents, and publications cited above are hereby incorporated by reference.

The various implementations described above can be combined to provide further implementations. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the implementations can be modified, if necessary to employ concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. An apparatus for mixing two or more substances into a mixed blend, the apparatus comprising:
(a) a first surface, the first surface having a first profile,
(b) a second surface spaced apart from the first surface, the second surface having a second profile,
(c) a mixing gap formed between the first and second profiles of the first surface and the second surface, and (d) at least one input channel in liquid communication with the mixing gap, to feed the mixing gap with the two or more substances to be mixed, wherein at least one of the first surface and the second surface is a rotating surface, and wherein the first profile and the second profile are configured to mix and disperse the two or more substances flowing through the mixing gap together using one or more of high shear, cavitation and impacting forces.

2. The apparatus of claim 1, wherein the profile of at least one of the first surface and the second surface comprises alternate curved surfaces.

3. The apparatus of claim 1, wherein the profile of both the first surface and the second surface comprise alternate curved surfaces.

4. The apparatus according to claim 1, wherein the apparatus further comprises a container for receiving the mixed blend from the mixing gap.

5. The apparatus according to claim 1, wherein the mixing gap includes a narrow portion and a broad portion, wherein distance between the first surface and the second surface is longer in the broad portion than in the narrow portion.

6. The apparatus according to claim 1, wherein the apparatus further comprises a driving means linked to the first surface for rotating the first surface in the predetermined direction.

7. The apparatus according to claim 1, wherein the apparatus further comprises a driving means linked to the second surface for rotating the second surface in the predetermined direction.

8. The apparatus according to claim 1, wherein the apparatus further comprises at least one heating cartridge connected to the one or both of the first surface and second surface.

9. The apparatus according to claim 1, wherein the apparatus further comprises an ultrasonic or low frequency transducer connected to one or both of the first surface and the second surface to apply ultrasonic and/or low frequency vibrations into the substances being mixed at the gap.

10. The apparatus according to claim 1, wherein at least one of the first profile or second profile includes an airfoil or hydrofoil profile.

11. The apparatus according to claim 1, wherein the apparatus further includes air injection lines in communication with the mixing gap to promote cavitation on the substances flowing through the gap.

12. The apparatus according to claim 1, wherein the first profile of the first surface includes first set of structures that project into the mixing gap and mate with grooves formed in the second profile which form interdigitations in the mixing gap.

13. The apparatus according to claim 1, wherein the apparatus further comprises at least one electrode pair connected to the first surface and the second surface, that generate an electric field between the first surface and the second surface.

14. The apparatus according to claim 1, wherein the second surface is coaxial to the first surface.

15. The apparatus according to claim 1, wherein the second surface is co-planar to the first surface.

16. The apparatus according to claim 1, wherein the two or more substances is a liquid and a solid, and wherein the mixed blend is a homogeneous blend of the solids suspended in the liquid.

17. A method of mixing two or more substances into a mixed blend, the method comprising: (a) providing an apparatus according to claim 1, (b) feeding the two or more substances through the input channel, (c) rotating at least one of the first surface or the second surface while the two or more substances flow through the mixing gap thereby mixing the substances, and (d) collecting the mixed blend.

18. A method of mixing two or more substances into a mixed blend, the method comprising: (a) passing two or more substances through a gap formed by two co-axial surfaces, the two co-axial surfaces having profiles such that the distance between the two co-axial surfaces varies throughout the gap, at least one of the two co-axial surfaces being capable of rotating, (b) rotating at least one of the two co-axial surfaces while the two or more substances pass through the gap thereby mixing the substances, and (c) collecting the mixed blend.

19. A composition produced by an apparatus according to claim 1.

20. The composition of claim 19, wherein the two or more substances is a liquid and particles, and wherein the composition is a homogenous blend of the particles suspended in the liquid.
